(19) United States
(12) Patent Application Publication
(10) Pub. No.: US 2009/0286593 A1
(43) Pub. Date: Nov. 19, 2009

(54) METHOD OF GAMING AND GAMING SYSTEM

(76) Inventor: Chi We Chim, Castle Hill (AU)

Correspondence Address: MCANDREWS HELD & MALLOY, LTD, 500 WEST MADISON STREET, SUITE 3400, CHICAGO, IL, 60661, US

(21) Appl. No.: 12/465,418

(22) Filed: May 13, 2009

(30) Foreign Application Priority Data
May 13, 2008 (AU) 2008902342

(51) Int. Cl. A63F 9/24; A63F 13/00

(52) U.S. Cl. 463/20; 463/42; 463/46; 463/30

(57) ABSTRACT

A method of gaming comprising: determining a number of arrangements of symbol display positions to be played in a base game; and controlling the probability of awarding a feature game from the base game so that the probability is proportional to the number of arrangements played.

### RELATED APPLICATIONS

This application claims priority to Australian Provisional Patent Application No. 2008902342 having a filing date of May 13, 2008, which is incorporated herein by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention relates to a method of gaming and a gaming system.

Current electronic gaming machines allow a player to place a wager or bet, in return for which a play of the game provided by the gaming machine is conducted. Many gaming machines implement a base game and a feature game which is triggered from the base game if one or more trigger events occur. The feature game may be arranged to award a jackpot prize.

While such gaming systems provide users with enjoyment, a need exists for alternative gaming systems in order to maintain or increase player enjoyment.

### BRIEF SUMMARY OF THE INVENTION

In a first aspect, the invention provides a method of gaming comprising:
determining a number of arrangements of symbol display positions to be played in a base game; and
controlling the probability of awarding a feature game from the base game so that the probability is proportional to the number of arrangements played and independent of the amount wagered on the base game.

In an embodiment, the symbol display positions are a set of symbol display positions corresponding to a plurality of spinning reels and the method involves determining a plurality of symbols for display at the display positions and evaluating whether the symbols at the arrangements of symbol display positions played correspond to a trigger to award the feature game.

In an embodiment, the arrangements of symbol display positions played correspond to combinations of symbol display positions in accordance with at least one game rule, each combination consisting of one symbol display position from each reel.

In an embodiment, each combination corresponds to a win line.

In an embodiment, each combination is derived by combining selected display positions of the plurality of reels.

In an embodiment, the selected display positions are derived from selected reels.

In an embodiment, the feature game comprises determining whether to make an award of a jackpot.

In a second aspect, the invention provides a method of gaming comprising:
determining a number of arrangements of symbol display positions to be played in a base game;
awarding a feature game from the base game in response to a trigger event occurring; and
controlling the probability of awarding a jackpot from the feature game so that the probability of awarding the jackpot is proportional to a number of credits played per arrangement in the base game.

In an embodiment, the method comprises controlling the probability of awarding the feature game from the base game so that the probability is proportional to the number of arrangements played and independent of the amount wagered on the base game.

In an embodiment, the symbol display positions are a set of symbol display positions corresponding to a plurality of spinning reels and the method involves determining a plurality of symbols for display at the display positions and evaluating whether the symbols at the arrangements of symbol display positions played correspond to the trigger event.

In an embodiment, the jackpot comprises at least one jackpot prize and a consolation prize wherein the probability of awarding each jackpot prize is related to the number of credits played per arrangement in the base game.

In an embodiment, the probability of awarding the consolation prize is the complement of the combined probabilities of awarding each jackpot prize.

In an embodiment, the consolation prize corresponds to a fixed number of credits such that the probability of awarding the jackpot prize with a higher number of credits than the consolation prize is related to the number of credits played per arrangement in the base game.

In a third aspect, the invention provides a gaming system comprising:
a display;
a game play mechanism operable by a player to select a number of arrangements of symbol display positions to be played; and
a game controller arranged to:
   implement a base game with the selected number of arrangements,
   control the probability of awarding a feature game from the base game so that the probability is proportional to the number of arrangements played in the base game and independent of the amount wagered on the base game.

In an embodiment, the symbol display positions are a set of symbol display positions corresponding to a plurality of spinning reels and the game controller determines a plurality of symbols for display at the display positions and evaluates whether the symbols at the arrangements of symbol display positions played correspond to a trigger to award the feature game.

In an embodiment, the arrangements of symbol display positions played correspond to combinations of symbol display positions in accordance with at least one game rule, each combination consisting of one symbol display position from each reel.

In an embodiment, each combination corresponds to a win line.

In an embodiment, each combination is derived by combining selected display positions of the plurality of reels.

In an embodiment, the selected display positions are derived from selected reels.

In an embodiment, in the feature game, the game controller determines whether to make an award of a jackpot.

In a fourth aspect, the invention provides a gaming system comprising:
a display;
   a game play mechanism operable by a player to select a number of arrangements of symbol display positions to be played and to select a number of credits to be played per arrangement; and
   a game controller arranged to:
      implement a base game with the selected number of arrangements;
      awarding a feature game from the base game in response to a trigger event occurring; and
      control the probability of awarding a jackpot from the feature game so that the probability of awarding the jackpot is proportional to the number of credits played per arrangement in the base game.

In an embodiment, the game controller controls the probability of awarding the feature game from the base game so that the probability is proportional to the number of arrangements played and independent of the amount wagered on the base game.

In an embodiment, the symbol display positions are a set of symbol display positions corresponding to a plurality of spinning reels and the game controller determines a plurality of symbols for display at the display positions and evaluates whether the symbols at the arrangements of symbol display positions played correspond to the trigger event.

In an embodiment, the jackpot comprises at least one jackpot prize and a consolation prize, and wherein the probability of awarding each jackpot prize is related to the number of credits played per arrangement in the base game.

In an embodiment, the probability of awarding the consolation prize is the complement of the combined probabilities of awarding each jackpot prize.

In an embodiment, the consolation prize corresponds to a fixed number of credits such that the probability of awarding the jackpot prize with a higher number of credits than the consolation prize is related to the number of credits played per arrangement in the base game.

In a fifth aspect, the invention provides a game controller for a gaming system, the game controller arranged to:
receive a number of arrangements of symbol display positions to be played;
implement the base game with the selected number of arrangements; and
control the probability of awarding a feature game from the base game so that the probability is proportional to the number of arrangements played in the base game and independent of the amount wagered on the base game.

In an embodiment, the game controller comprises an outcome generator to generate a game outcome including selecting a plurality of symbols for display at the display positions, the selected symbols corresponding to a plurality of spinning reels set side by side.

In an embodiment, the game controller comprises an outcome evaluator to evaluate the game outcome by evaluating the symbols at the arrangements of symbol display positions played.

In an embodiment, the game controller comprises a trigger evaluator to evaluate whether the symbols at the arrangements of symbol display positions played corresponds to a trigger to award the feature game.

In an embodiment, the game controller comprises a jackpot evaluator to evaluate whether the symbols at the arrangements of symbol display positions played corresponds to a trigger to award the jackpot.

In an embodiment, the arrangements of symbol display positions played correspond to combinations of symbol display positions in accordance with at least one game rule, each combination consisting of one symbol display position from each reel.

In an embodiment, each combination corresponds to a win line.

In an embodiment, each combination is derived by combining selected display positions of the plurality of reels.

In an embodiment, the selected display positions are derived from selected reels.

In a sixth aspect, the invention provides a game controller for a gaming system, the game controller arranged to:
receive a number of arrangements of symbol display positions to be played;
receive a number of credits to be played per arrangement;
implement a base game with the selected number of arrangements;
award a feature game from the base game in response to a trigger event occurring; and
control the probability of awarding a jackpot from the feature game so that the probability of awarding the jackpot is proportional to the number of credits played per arrangement in the base game.

In an embodiment, the game controller comprises an outcome generator to generate a game outcome including selecting a plurality of symbols for display at the display positions, the selected symbols corresponding to a plurality of spinning reels set side by side.

In an embodiment, the game controller comprises an outcome evaluator to evaluate the game outcome by evaluating the symbols at the arrangements of symbol display positions played.

In an embodiment, the game controller comprises a trigger evaluator to evaluate whether the symbols at the arrangements of symbol display positions played corresponds to the trigger event to award the feature game.

In an embodiment, the game controller comprises a jackpot evaluator to evaluate whether the symbols at the arrangements of symbol display positions played corresponds to a trigger to award the jackpot.

In an embodiment, the game controller controls the probability of awarding the feature game from the base game so that the probability is proportional to the number of arrangements played and independent of the amount wagered on the base game.

In a seventh aspect, the invention provides a gaming system comprising:
means for determining a number of arrangements of symbol display positions to be played in a base game; and
means for controlling the probability of awarding a feature game from the base game so that the probability is proportional to the number of arrangements played and independent of the amount wagered on the base game.

In an eighth aspect, the invention provides a gaming system comprising:
means for determining a number of arrangements of symbol display positions to be played in a base game;
means for awarding a feature game from the base game in response to a trigger event occurring; and
means for controlling the probability of awarding a jackpot from the feature game so that the probability of awarding the jackpot is proportional to a number of credits played per arrangement in the base game.

In a ninth aspect, the invention provides a gaming machine comprising:
display mounted within a cabinet;
at least one input device mounted to the cabinet, operable by a player to select a number of arrangements of symbol display positions to be played; and
a game controller mounted within the cabinet and in data communication with the display and each input device, the game controller comprising a processor and a memory storing instructions which when executed by the processor causes the game controller to implement a base game with the selected number of arrangements which is displayed on the display and control the probability of awarding a feature game from the base game so that the probability is proportional to the number of arrangements played in the base game and independent of the amount wagered on the base game.

In a tenth aspect, the invention provides a gaming machine comprising:
display mounted within a cabinet;
at least one input device mounted to the cabinet, operable by a player to select a number of arrangements of symbol display positions to be played and to select a number of credits to be played per arrangement; and
a game controller mounted within the cabinet and in data communication with the display and each input device, the game controller comprising a processor and a memory storing instructions which when executed by the processor causes the game controller to implement a base game with the selected number of arrangements, award a feature game from the base game in response to a trigger event occurring, and control the probability of awarding a jackpot from the feature game so that the probability of awarding the jackpot is proportional to the number of credits played per arrangement in the base game.

In an eleventh aspect, the invention provides a computer program code which when executed implements the above method.

In a twelfth aspect, the invention provides a computer readable medium comprising the above program code.

In a thirteenth aspect, the invention provides transmitting or receiving the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

### DETAILED DESCRIPTION OF THE INVENTION

Referring to the drawings, there is shown a method and gaming system having a game controller arranged to implement a game having a number of aspects. In one aspect a feature game is awarded from a base game and the probability of awarding the feature game is proportional to a number of arrangements played in the base game. In another aspect, the possibility of awarding a jackpot in the feature game is controlled based on an amount wagered.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

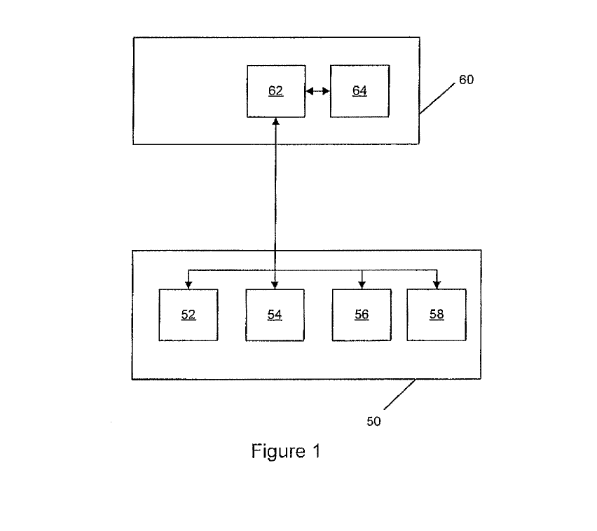

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 comprising one or more input devices that enable a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

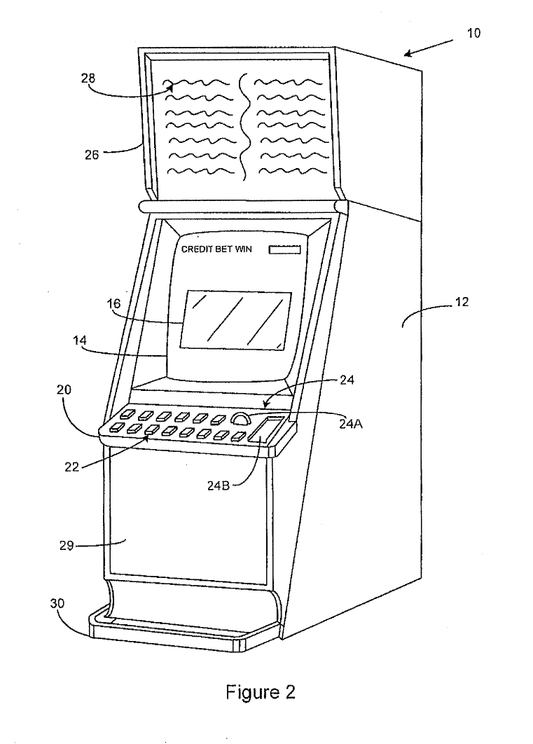

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

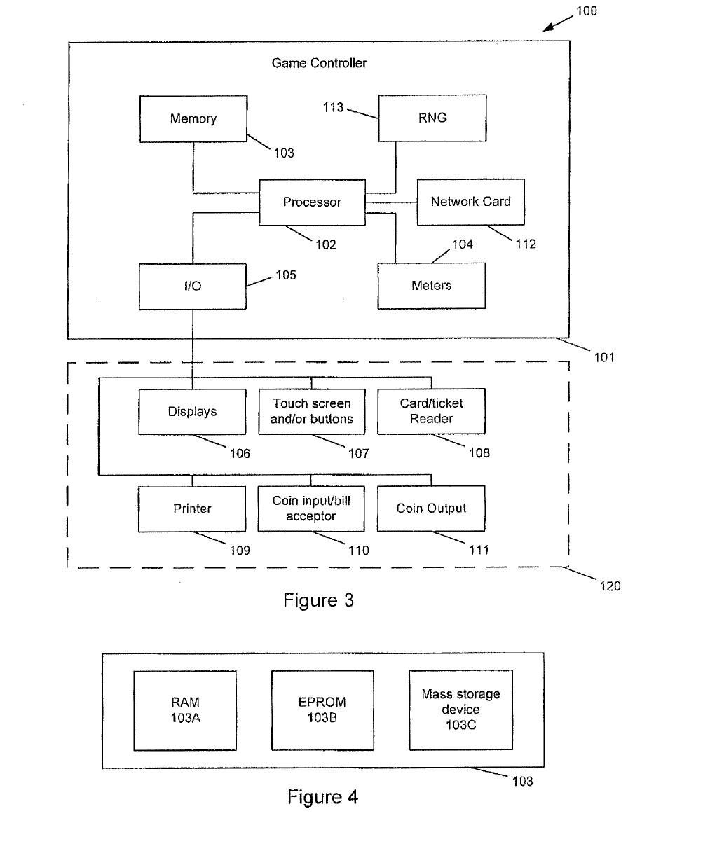

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

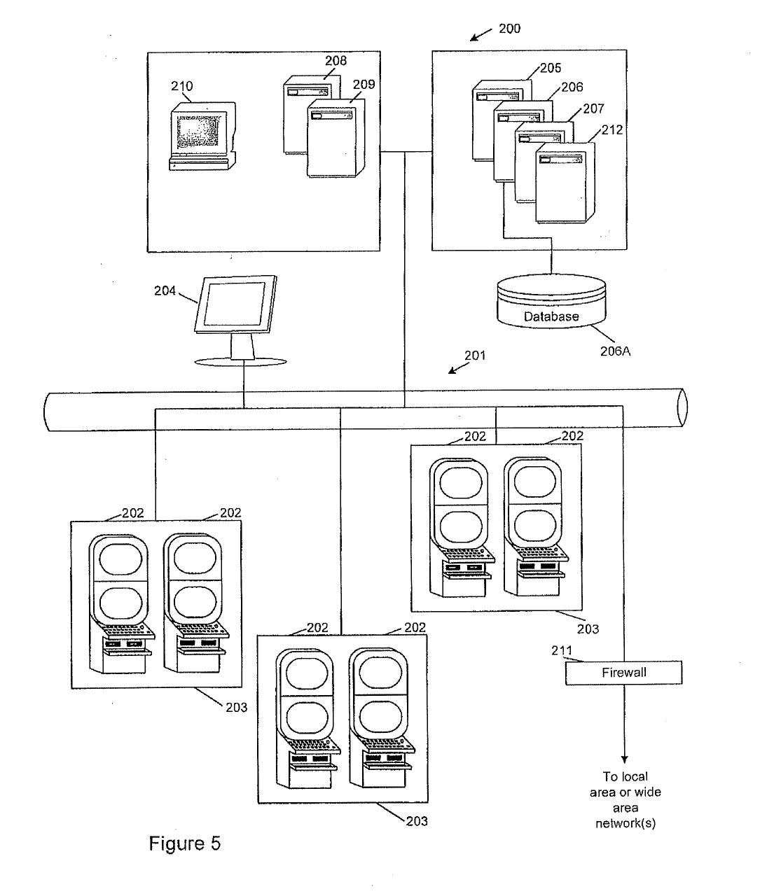

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

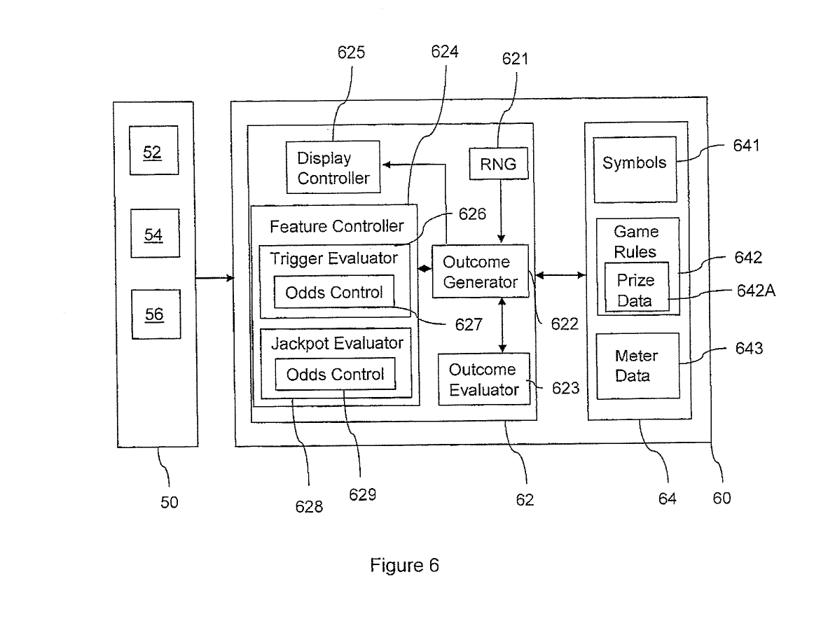

Referring to FIG. 6, the player operates game play mechanism 56 to input a number of arrangements of symbol display positions to be played. This forms part of an initiate play instruction selected from one of a plurality of available initiate play instructions. Another part of the initiate play instruction is the number of credits bet, or played per arrangement.

In one embodiment, the outcome evaluator 623 will evaluate a plurality of arrangements of symbol display positions specified by game rule data 642. The arrangements correspond to combinations of symbol display positions where, in one example, each combination consists of one symbol display position from each reel according to the game rule data. Depending on the embodiment, the combinations of symbol display positions can be in the form of a plurality of win lines or can be derived by combining selected display positions of the reels.

The outcome generator 622 operates in response to the player's operation of game play mechanism 56 to generate a game outcome which will then be evaluated by outcome evaluator 623. The outcome generator forms the game outcome by employing random number generator 621 to randomly select symbols from a set of symbols specified by symbol data 641. The selected symbols are advised to the display controller 625 which causes them to be displayed on display 54 at a set of display positions. In one embodiment, outcome generator 622 selects symbols for display from a plurality of symbol sets corresponding to respective ones of a plurality of spinning reels. Thus, the symbol sets 641 specify a sequence of symbols for each reel such that the outcome generator 622 can, in one example, select symbols for display by selecting a stopping position in the sequence. In one example, three symbols of each of five reels may be displayed such that symbols are displayed at fifteen display positions on display 54. To obtain a desired return to player, a probability table having weighted outcomes may be employed when selecting the symbols.

Outcome evaluator 623 evaluates each of the number of arrangements played by the player to determine which, if any, of the arrangements correspond to a winning combination specified in the prize data 642A based on game rules 642. For example, the game rules may specify that all combinations are evaluated left to right or can be evaluated right to left or both.

In one embodiment, feature controller 624 includes a trigger evaluator 626 to evaluate the number of arrangements played which correspond to a trigger for a feature (or secondary) game. The probability of awarding the feature game is controlled by a trigger odds controller 627 so that the probability of awarding the feature game from the base game is proportional to the number of arrangements played in the base game and is not dependent of the amount wagered on an outcome of the base game.

By way of example, the feature game may be a series of free games, in which case outcome evaluator 623 triggers outcome generator 622 to carry out a series of one or more free games and outcome evaluator 623 evaluates each of these games to determine whether the arrangements played correspond to a winning combination specified in the prize data 642A based on game rules. Jackpot evaluator 628 evaluates whether any of these games contain a winning combination of symbols so that a jackpot can be awarded. The probability of awarding the jackpot from the feature game is controlled by a jackpot odds controller 629 so that the probability of awarding the jackpot is proportional to the number of credits played per arrangement played in the base game.

By way of example, a sample game will be described. In the sample game, the probability of the player triggering the feature game is a 1 in 24500 chance. If the player increases the number of arrangements played, the chance of triggering the feature game increases proportionally. For example, playing 25 arrangements will give the player a 25 in 24500 chance of triggering the feature game

The jackpot in the sample game includes at least one jackpot prize and a consolation prize and, in one embodiment, includes four jackpot prizes, namely, a grand, major, minor and mini jackpot prize. Sample probabilities of winning the jackpot prizes from the feature game are described in Tables 1 and 2.

Table 1 shows an example of the chance of winning the jackpot prizes betting 1 credit per arrangement of symbol display positions played in the base game.

TABLE 1

| Prize | Probability |
|---|---|
| Grand | 0.0002 |
| Major | 0.0028 |
| Minor | 0.0700 |
| Mini | 0.1070 |
| Consolation | 0.8200 |

Table 2 shows an example of the chance of winning the jackpots betting 5 credits per arrangement of symbol display positions played in the same base game is:

TABLE 2

| Prize | Probability |
|---|---|
| Grand | 0.0010 |
| Major | 0.0140 |
| Minor | 0.3500 |
| Mini | 0.5350 |
| Consolation | 0.1000 |

It will be appreciated from Tables 1 and 2 that in this game, the chance of winning the consolation prize is therefore the complement of the combined probabilities of winning the jackpot prizes. In one embodiment, the consolation prize corresponds to a fixed number of credits whilst the jackpot prizes are proportional to the number of credits bet. Thus, the chance of winning the jackpot prize with a higher number of credits than the consolation prize is related to the number of credits played per arrangement. Thus, the number of arrangements played increases the probability of triggering the feature game and the number of credits played per arrangement increases the value of the prize once in the feature game.

Also envisaged is the feature game having a random bonus prize awarded at a fixed probability regardless of the number of credits played. However, it is envisaged that the random bonus prize may also increase with the number of credits played per arrangement.

The trigger evaluator 626 may also make additional evaluations known in the art, for example “scatters” (scattered symbols) where a player is awarded a prize or the feature game for a designated number of symbols, irrespective of whether they are on a played arrangement of symbol positions. The probability of awarding the feature game by displaying a designated number of “scatters” is also controlled by the odds controller of the trigger evaluator.

The jackpot evaluator 628 determines the jackpot and thus the quantum of the prize to be made from the initiate play instruction (i.e. the number of arrangements played and the number of credits per arrangement) and the prizes are accumulated to a win meter stored as meter data 643. Once all outcomes have been generated and a further game play instruction is required before any further play can occur, credits are transferred to a credit meter in meter data 643. In embodiments, where a gamble feature is offered it may be possible, for example to seek to double the accumulated win at the risk of losing it. In such embodiments, it may be necessary for a player to operate the game play mechanism 56 to indicate they want to take an accumulated win or to initiate a further play of the game before credits are transferred from the win meter to the credit meter.

Persons skilled in the art will appreciate that the arrangements of symbol display positions played correspond to combinations of symbol display positions in accordance with the game rules 642. A win line corresponds to the combinations of displayed symbol positions, one from each reel, being located relative to one another such that they form a line. Examples of win lines are given in Australian patent 684195 owned by Aristocrat Technologies Australia Pty. Ltd.

Persons skilled in the art will appreciate that in other embodiments, the outcome evaluator may evaluate symbol combinations in a different way. For example, in the manner in which outcomes are evaluated in games marketed under the trade name “Reel Power” by Aristocrat Leisure Industries Pty Ltd and described in U.S. Pat. No. 6,093,102. Such arrangements of games symbol combinations are made by forming combinations from each selected reel by combining it with all the selected positions of other reels. In other words, all symbol positions of a selected reel can be used to form symbol combinations with designated, symbol display positions of other reels. This means that in embodiments where there are three symbols displayed for each reel and five reels, there are 243 different symbol combinations (35) to be evaluated by the outcome evaluator (also known as “ways” to win). Thus in this embodiment, the game rules 642 may specify for example the evaluation of 2, 3, 4 or 5 reels irrespective of the game play instruction. This may be configurable by the operator.

In the above description it will be appreciated that the various of the above functional modules are implemented by processor 62 executing code stored in memory 64. Persons skilled in the art will appreciate that other embodiments are possible including dedicated circuits.

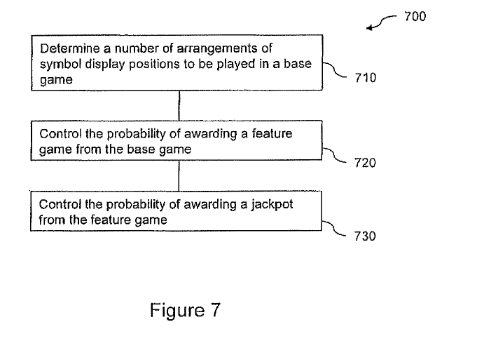

A method 700 combining both aspects is summarised in FIG. 7 and involves determining 710 a number of arrangements of symbol display positions to be played in a base game. The method also involves controlling 720 the probability of awarding a feature game from the base game so that the probability is proportional to the number of arrangements played. Where the feature game is triggered, the method further includes controlling 730 the probability of awarding a jackpot from the feature game so that the probability is proportional to the number of credits played in the base game.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server which results in the program code being transmitted from the server to a gaming machine or computer which receives it).

It will be understood to persons skilled in the art of the invention that many modifications may be made without departing from the spirit and scope of the invention, in particular it will be apparent that certain features of the invention can be combined to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
determining a number of arrangements of symbol display positions to be played in a base game; and
controlling the probability of awarding a feature game from the base game so that the probability is proportional to the number of arrangements played and independent of the amount wagered on the base game.

2. A method of gaming as claimed in claim 1, wherein the symbol display positions are a set of symbol display positions corresponding to a plurality of spinning reels and the method involves determining a plurality of symbols for display at the display positions and evaluating whether the symbols at the arrangements of symbol display positions played correspond to a trigger to award the feature game.

3. A method of gaming as claimed in claim 2, wherein the arrangements of symbol display positions played correspond to combinations of symbol display positions in accordance with at least one game rule, each combination consisting of one symbol display position from each reel.

4. A method of gaming as claimed in claim 3, wherein each combination corresponds to a win line.

5. A method of gaming as claimed in claim 3, wherein each combination is derived by combining selected display positions of the plurality of reels.

6. A method of gaming as claimed in claim 5, wherein the selected display positions are derived from selected reels.

7. A method of gaming as claimed in claim 1, wherein the feature game comprises determining whether to make an award of a jackpot.

8. A method of gaming comprising:
determining a number of arrangements of symbol display positions to be played in a base game;
awarding a feature game from the base game in response to a trigger event occurring; and
controlling the probability of awarding a jackpot from the feature game so that the probability of awarding the jackpot is proportional to a number of credits played per arrangement in the base game.

9. A method of gaming as claimed in claim 8, comprising controlling the probability of awarding the feature game from the base game so that the probability is proportional to the number of arrangements played and independent of the amount wagered on the base game.

10. A method of gaming as claimed in claim 8, wherein the symbol display positions are a set of symbol display positions corresponding to a plurality of spinning reels and the method involves determining a plurality of symbols for display at the display positions and evaluating whether the symbols at the arrangements of symbol display positions played correspond to the trigger event.

11. A method of gaming as claimed in claim 8, wherein the jackpot comprises at least one jackpot prize and a consolation prize wherein the probability of awarding each jackpot prize is related to the number of credits played per arrangement in the base game.

12. A method of gaming as claimed in claim 11, wherein the probability of awarding the consolation prize is the complement of the combined probabilities of awarding each jackpot prize.

13. A method of gaming as claimed in claim 12, wherein the consolation prize corresponds to a fixed number of credits such that the probability of awarding the jackpot prize with a higher number of credits than the consolation prize is related to the number of credits played per arrangement in the base game.

14. A gaming system comprising:
a display;
a game play mechanism operable by a player to select a number of arrangements of symbol display positions to be played; and
a game controller arranged to:
implement a base game with the selected number of arrangements,
control the probability of awarding a feature game from the base game so that the probability is proportional to the number of arrangements played in the base game and independent of the amount wagered on the base game.

15. A gaming system as claimed in claim 14, wherein the symbol display positions are a set of symbol display positions corresponding to a plurality of spinning reels and the game controller determines a plurality of symbols for display at the display positions and evaluates whether the symbols at the arrangements of symbol display positions played correspond to a trigger to award the feature game.

16. A gaming system as claimed in claim 15, wherein the arrangements of symbol display positions played correspond to combinations of symbol display positions in accordance with at least one game rule, each combination consisting of one symbol display position from each reel.

17. A gaming system as claimed in claim 16, wherein each combination corresponds to a win line.

18. A gaming system as claimed in claim 16, wherein each combination is derived by combining selected display positions of the plurality of reels.

19. A gaming system as claimed in claim 18, wherein the selected display positions are derived from selected reels.

20. A gaming system as claimed in claim 14, wherein in the feature game, the game controller determines whether to make an award of a jackpot.

21. A gaming system comprising:
a display;
a game play mechanism operable by a player to select a number of arrangements of symbol display positions to be played and to select a number of credits to be played per arrangement; and
a game controller arranged to:
implement a base game with the selected number of arrangements;
awarding a feature game from the base game in response to a trigger event occurring; and
control the probability of awarding a jackpot from the feature game so that the probability of awarding the jackpot is proportional to the number of credits played per arrangement in the base game.

22. A gaming system as claimed in claim 21, wherein the game controller controls the probability of awarding the feature game from the base game so that the probability is proportional to the number of arrangements played and independent of the amount wagered on the base game.

23. A gaming system as claimed in claim 21, wherein the symbol display positions are a set of symbol display positions corresponding to a plurality of spinning reels and the game controller determines a plurality of symbols for display at the display positions and evaluates whether the symbols at the arrangements of symbol display positions played correspond to the trigger event.

24. A gaming system as claimed in claim 21, wherein the jackpot comprises at least one jackpot prize and a consolation prize, and wherein the probability of awarding each jackpot prize is related to the number of credits played per arrangement in the base game.

25. A gaming system as claimed in claim 24, wherein the probability of awarding the consolation prize is the complement of the combined probabilities of awarding each jackpot prize.

26. A method of gaming as claimed in claim 25, wherein the consolation prize corresponds to a fixed number of credits such that the probability of awarding the jackpot prize with a higher number of credits than the consolation prize is related to the number of credits played per arrangement in the base game.

27. A game controller for a gaming system, the game controller arranged to:
receive a number of arrangements of symbol display positions to be played;
implement the base game with the selected number of arrangements; and
control the probability of awarding a feature game from the base game so that the probability is proportional to the number of arrangements played in the base game and independent of the amount wagered on the base game.

28. A game controller as claimed in claim 27, comprising an outcome generator to generate a game outcome including selecting a plurality of symbols for display at the display positions, the selected symbols corresponding to a plurality of spinning reels set side by side.

29. A game controller as claimed in claim 28, comprising an outcome evaluator to evaluate the game outcome by evaluating the symbols at the arrangements of symbol display positions played.

30. A game controller as claimed in claim 28, comprising a trigger evaluator to evaluate whether the symbols at the arrangements of symbol display positions played corresponds to a trigger to award the feature game.

31. A game controller as claimed in claim 28, comprising a jackpot evaluator to evaluate whether the symbols at the arrangements of symbol display positions played corresponds to a trigger to award the jackpot.

32. A game controller as claimed in claim 28, wherein the arrangements of symbol display positions played correspond to combinations of symbol display positions in accordance with at least one game rule, each combination consisting of one symbol display position from each reel.

33. A game controller as claimed in claim 32, wherein each combination corresponds to a win line.

34. A game controller as claimed in claim 32, wherein each combination is derived by combining selected display positions of the plurality of reels.

35. A game controller as claimed in claim 34, wherein the selected display positions are derived from selected reels.

36. A game controller for a gaming system, the game controller arranged to:
receive a number of arrangements of symbol display positions to be played;
receive a number of credits to be played per arrangement;
implement a base game with the selected number of arrangements;
award a feature game from the base game in response to a trigger event occurring; and
control the probability of awarding a jackpot from the feature game so that the probability of awarding the jackpot is proportional to the number of credits played per arrangement in the base game.

37. A game controller as claimed in claim 36, comprising an outcome generator to generate a game outcome including selecting a plurality of symbols for display at the display positions, the selected symbols corresponding to a plurality of spinning reels set side by side.

38. A game controller as claimed in claim 36, comprising an outcome evaluator to evaluate the game outcome by evaluating the symbols at the arrangements of symbol display positions played.

39. A game controller as claimed in claim 36, comprising a trigger evaluator to evaluate whether the symbols at the arrangements of symbol display positions played corresponds to the trigger event to award the feature game.

40. A game controller as claimed in claim 36, comprising a jackpot evaluator to evaluate whether the symbols at the arrangements of symbol display positions played corresponds to a trigger to award the jackpot.

41. A game controller as claimed in claim 36, wherein the game controller controls the probability of awarding the feature game from the base game so that the probability is proportional to the number of arrangements played and independent of the amount wagered on the base game.

42. A gaming system comprising:
means for determining a number of arrangements of symbol display positions to be played in a base game; and
means for controlling the probability of awarding a feature game from the base game so that the probability is proportional to the number of arrangements played and independent of the amount wagered on the base game.

43. A gaming system comprising:
means for determining a number of arrangements of symbol display positions to be played in a base game;
means for awarding a feature game from the base game in response to a trigger event occurring; and
means for controlling the probability of awarding a jackpot from the feature game so that the probability of awarding the jackpot is proportional to a number of credits played per arrangement in the base game.

44. A gaming machine comprising:
display mounted within a cabinet;
at least one input device mounted to the cabinet, operable by a player to select a number of arrangements of symbol display positions to be played; and
a game controller mounted within the cabinet and in data communication with the display and each input device, the game controller comprising a processor and a memory storing instructions which when executed by the processor causes the game controller to implement a base game with the selected number of arrangements which is displayed on the display and control the probability of awarding a feature game from the base game so that the probability is proportional to the number of arrangements played in the base game and independent of the amount wagered on the base game.

45. A gaming machine comprising:
display mounted within a cabinet;
at least one input device mounted to the cabinet, operable by a player to select a number of arrangements of symbol display positions to be played and to select a number of credits to be played per arrangement; and
a game controller mounted within the cabinet and in data communication with the display and each input device, the game controller comprising a processor and a memory storing instructions which when executed by the processor causes the game controller to implement a base game with the selected number of arrangements, award a feature game from the base game in response to a trigger event occurring, and control the probability of awarding a jackpot from the feature game so that the probability of awarding the jackpot is proportional to the number of credits played per arrangement in the base game.

46. A method as claimed in claim 1, further comprising a computer program code.

47. A method as claimed in claim 46, further comprising a computer readable medium comprising said program code.

48. A method as claimed in claim 46, further comprising transmitting or receiving said program code.
